(19) United States
(12) Patent Application Publication
(10) Pub. No.: US 2001/0028767 A1
(43) Pub. Date: Oct. 11, 2001

(54) Optical fibre to waveguide junction

(76) Inventor: Nicola J. Rutterford, Oxfordshire (GB)

Correspondence Address: SUGHRU, MION, ZINN, MACPEAK & SEAS, PLLC, 2100 PENNSYLVANIA AVENUE, N.W., WASHINGTON, DC, 20037-3213, US

(21) Appl. No.: 09/766,850

(22) Filed: Jan. 23, 2001

(30) Foreign Application Priority Data
Jan. 24, 2000 (GB) 0001555.2

(51) Int. Cl. G02B 6/30

(52) U.S. Cl. 385/49; 385/14; 385/50

(57) ABSTRACT

An integrated silicon waveguide device has a fibre connection in which a fibre is fixed between two silicon clamping blocks which are secured face to face with flat abutment faces on an end region of the waveguide device and on an abutment block of silicon secured to a surface of the waveguide device.

The invention relates to junctions between optical fibres and silicon waveguide devices.

### BACKGROUND OF THE INVENTION

Integrated silicon waveguide structures are known such as for example silicon ridge waveguide devices, in which optical fibres are coupled optically to the end of respective waveguides at an edge of an integrated silicon device. To bond an optical fibre to an edge region of an integrated waveguide device with the fibre in optical alignment with the waveguide, it is known to mount the end of the fibre between clamping blocks which are then secured by bonding to an edge face of the integrated silicon waveguide device.

It is an object of the present invention to provide an improved bonding structure which provides increased abutment area for bonding purposes while avoiding stresses arising in the bonded junction due to temperature variations.

### SUMMARY OF THE INVENTION

The invention provides an integrated silicon waveguide device having an optical fibre coupled thereto with an end of the fibre abutting a flat end face region of the waveguide device in optical alignment with a waveguide formed on the device, said optical fibre being fixed at said end between two silicon clamping blocks holding the fibre end between them and having flat faces adjacent the waveguide device and said waveguide device having on its surface an abutment block of silicon adjacent said end face region, wherein said abutment block and end face region provide flat abutment faces to which said clamping blocks are bonded in face to face abutment.

Preferably the bonding is effected by a region of epoxy resin.

Preferably the silicon waveguide device has at least one ridge waveguide formed on a silicon substrate.

Preferably the ridge waveguide is formed in an upper face of the waveguide device and said silicon abutment block is formed on the waveguide device over an end of said at least one waveguide adjacent said flat end face region.

Preferably the end of the optical fibre is sandwiched in grooves in each of the two clamping blocks, the grooves extending along the optical axis of the fibre to the flat faces of the blocks.

Preferably the flat faces of the two clamping blocks are coplanar. Preferably the abutment faces of the abutment block and the said end face region are coplanar.

Preferably the plane of the abutment block and the end face region is inclined at an angle to the vertical edge of the waveguide device to reduce back reflections at the end of the or each waveguide.

Preferably the direction of the optical fibre axis is inclined to the plane of the silicon waveguide device.

In some embodiments a plurality of fibres are secured between the clamping blocks to connect optically with a plurality of waveguides on the waveguide device.

### BRIEF DESCRIPTION OF THE DRAWINGS

FIG. 1 is a plan view of part of a device in accordance with the present invention,

FIG. 2 shows a side elevation of part of the device of FIG. 1,

FIG. 3 shows an end face of the integrated silicon waveguide device of FIG. 1, and

FIG. 4 shows an end face of an abutting clamped optical fibre.

### DESCRIPTION OF THE PREFERRED EMBODIMENT

The views of the embodiment shown in the Figures have been drawn to different scales in different Figures for the sake of clarity and the separate components within each Figure are not drawn to scale in order to show the nature of the components clearly. Although a single waveguide and single fibre have been shown in the part of the device illustrated in the drawings it will be understood that the device incorporates a plurality of waveguides and a plurality of optically coupled fibres each being coupled in the manner illustrated for one waveguide and one fibre in the drawings.

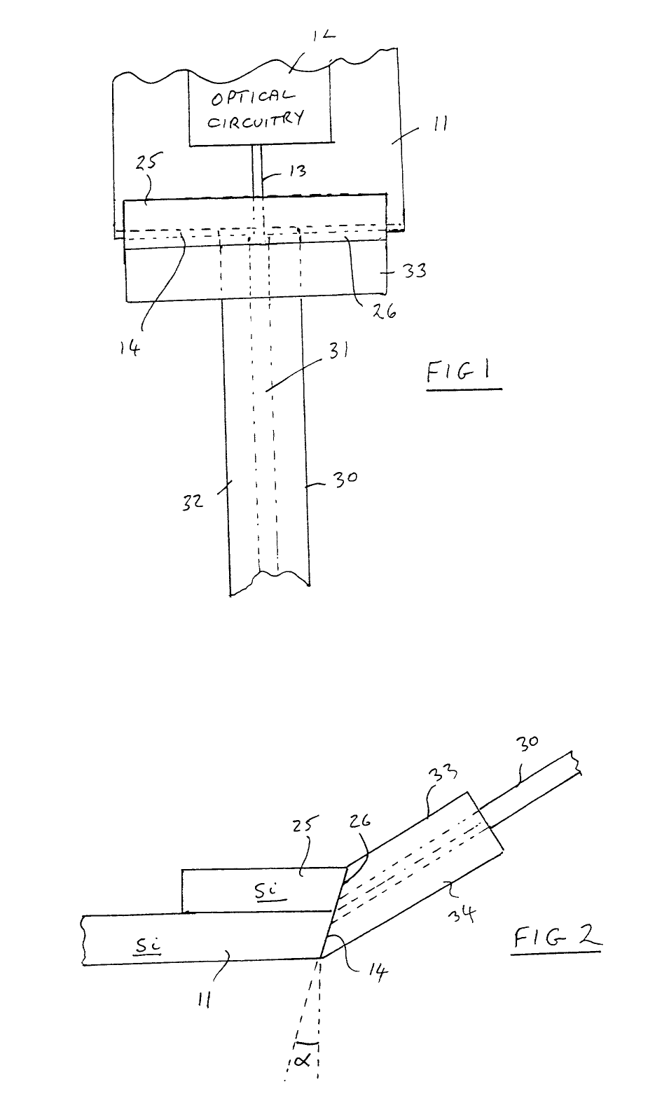

In FIG. 1 an integrated silicon chip 11 is formed as an integrated silicon wave device having optical circuitry 12 of known type coupled to a plurality of silicon ridge waveguides 13, one of which is shown in FIG. 1. The silicon chip 11 is generally a flat planar structure having the optical circuitry formed on the chip with the waveguide 13 extending across an upper surface of the planar chip towards a linear chip edge 14. The chip is formed with flat planar edges extending through the thickness of the chip although the edge 14 is angled at an angle a to the vertical as shown in FIG. 2.

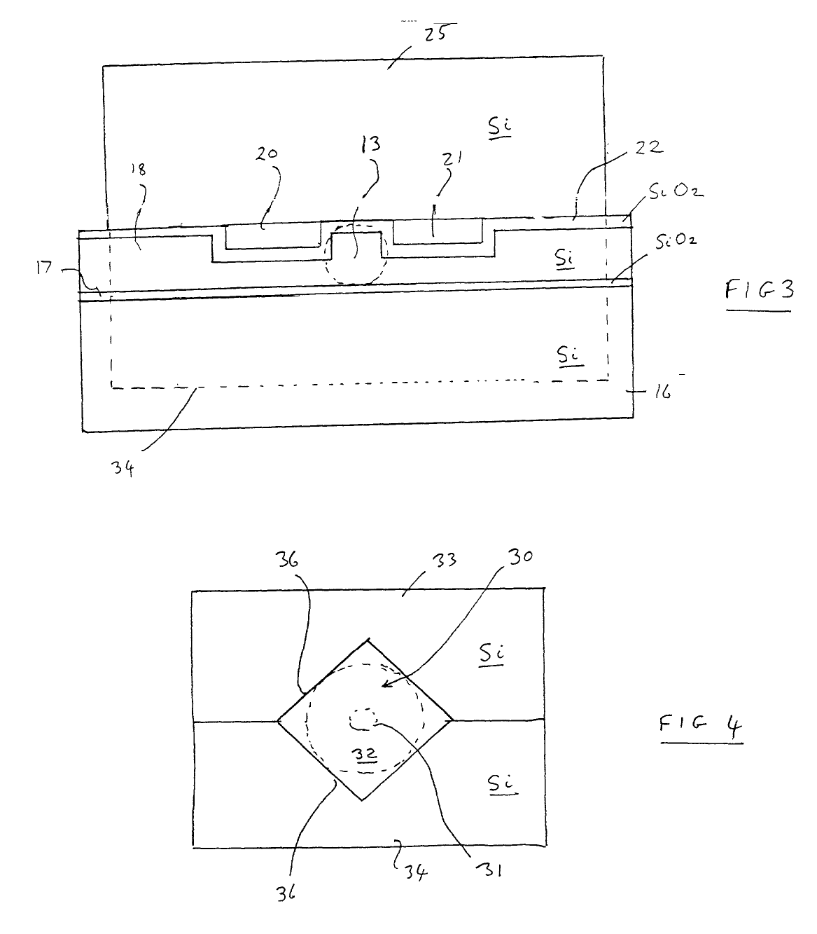

The structure of the chip and the end face 14 is illustrated more fully in FIG. 3 by the solid lines in FIG. 3. In this case a silicon substrate 16 supports a silicon oxide layer 17 on which is formed a silicon layer 18 having the ridge waveguide 13. The ridge 13 is formed between two trenches 20 and 21 on opposite sides of the ridge 13. A protective oxide layer 22 extends over the surface of the chip and over the ridge 13. Secured to the upper surface of the chip 11 adjacent the edge 14 is an abutment block 25 formed of silicon and having a flat face coplanar with the edge face 14 of the silicon chip. The block 25 overlies the waveguide 13 and has its outer face in alignment with the edge 14 thereby providing a large contact abutment face for use in securing an optical fibre.

As shown in FIG. 2 the block 25 has an angled edge face 26 aligned with the angled edge face 14.

An optical fibre 30 for coupling optically to the waveguide 13 has a core 31 surrounded by cladding 32. The entire fibre is mounted at its end adjacent the chip 11 in clamping blocks 33 and 34 each formed of silicon. Each of the blocks is formed with a V-shaped channel 36 extending through the blocks for the axial length of the fibre that is located within the blocks. In this way the fibre 30 is located in the two V-grooves 36 so as to be sandwiched between the upper and lower silicon blocks 33 and 34. The end face of the blocks is flat and angled relative to the optical axis of the fibre 30 so that the end face abuts in flat face to face contact with the end faces 14 and 26 of the chip 11 and abutment block 25. The area presented by the abutment block 25 and end face 14 is as great as the area of the clamping blocks 33 and 34 so as to provide the maximum contact area for bonding between the clamping blocks and the chip.

In assembly, the fibre is mounted between the blocks 33 and 34 and bonded together with them as a unit by the use of suitable adhesive such as epoxy resin. The end of the fibre terminates in the same plane as the end wall of the blocks 33 and 34 which is to abut the chip 11. The assembly of FIG. 4 is then held in position against the end face 14 of the chip 11 and end face 26 of the block 25 and adjusted in position to obtain the correct optical alignment between the fibre 30 and the waveguide 13. Epoxy resin is applied between the abutting faces of the box 33 and 34 and the chip 11 and block 25 and when in the correct position the bonding material such as epoxy resin is cured to secure the fibre assembly to the waveguide chip.

The abutment block 25 which is fixed in position on the chip 11 is formed of silicon so as to have the same thermal properties as the chip 11 and the clamping blocks 33 and 34 used for the optical fibre. In this way, the assembled unit has similar characteristics for each of the bonded members so that stresses are avoided such as those for example which would arise from temperature variations in use of the assembly.

It will be appreciated that the abutment block 25 being formed of silicon may be made on the chip 11 as part of the integrated circuit process or may be secured as a separate component bonded to the upper surface of the chip 11.

The faces 14 and 26 shown in FIG. 2 are inclined to the vertical so as to reduce back reflection effect for light transmitted to the waveguide 13 on the chip.

The abutment faces of the clamping blocks 33 and 34 which abut the edges 14 and 26 is angled to position the access of the optical fibre 30 in the correct alignment with light transmitted through the waveguide 13 and optical fibre 30. It will be understood that due to the different refractive index between silicon and glass which is used for the fibre 30, refraction occurs at the interface between the silicon and the glass and the alignment is such that after refraction light passes axially along both the optical fibre 30 and waveguide 13.

The invention is not limited to the details of the foregoing example.

1. An integrated silicon waveguide device having an optical fibre coupled thereto with an end of the fibre abutting a flat end face region of the waveguide device in optical alignment with a waveguide formed on the device, said optical fibre being fixed at said end between two silicon clamping blocks holding the fibre end between them and having flat faces adjacent the waveguide device and said waveguide device having on its surface an abutment block of silicon adjacent said end face region, wherein said abutment block and end face region provide flat abutment faces to which said clamping blocks are bonded in face to face abutment.

2. A waveguide device according to claim 1 in which the bonding is effected by a region of epoxy resin.

3. A waveguide device according to claim 1 in which the silicon waveguide device has at least one ridge waveguide formed on a silicon substrate.

4. A waveguide device according to claim 3 in which the ridge waveguide is formed in an upper face of the waveguide device and said silicon abutment block is formed on the waveguide device over an end of said at least one waveguide adjacent said flat end face region.

5. A waveguide device according to claim 1 in which the end of the optical fibre is sandwiched in grooves in each of the two clamping blocks, the grooves extending along the optical axis of the fibre to the flat faces of the blocks.

6. A waveguide device according to claim 1 in which the flat faces of the two clamping blocks are coplanar.

7. A waveguide device according to claim 1 in which the abutment faces of the abutment block and the said end face region are coplanar.

8. A waveguide device according to claim 7 in which the plane of the abutment block and the end face region is inclined at an angle to the vertical edge of the waveguide device to reduce back reflections at the end of the or each waveguide.

9. A waveguide device according to claim 1 in which the direction of the optical fibre axis is inclined to the plane of the silicon waveguide device.

10. A waveguide device according to claim 1 in which a plurality of fibres are secured between the clamping blocks to connect optically with a plurality of waveguides on the waveguide device.
